(19) United States
(12) Patent Application Publication
(10) Pub. No.: US 2010/0156832 A1
(43) Pub. Date: Jun. 24, 2010

(54) ERGONOMIC KEYBOARD AND LAPTOP

(76) Inventor: ANDREA E. VARGAS, FREMONT, CA (US)

Correspondence Address: James Ray & Associates, 2640 Pitcairn Road, Monroeville, PA, 15146, US

(21) Appl. No.: 12/640,359

(22) Filed: Dec. 17, 2009

Related U.S. Application Data
(60) Provisional application No. 61/139,251, filed on Dec. 19, 2008.
(60) Provisional application No. 61/139,812, filed on Dec. 22, 2008.

(51) Int. Cl. G06F 3/041

(52) U.S. Cl. 345/173

(57) ABSTRACT

The present invention in several embodiments is an innovative touch screen keyboard designed to alleviate the strain that comes with using a computer everyday. This touch screen keyboard features a touch screen surface having touch screen keys which may be struck by an individual as if such individual were typing on a traditional computer keyboard. Such touch screen keyboard is split into sections which can be positioned by a user in specific relation to his or her hands for individual comfort. The touch screen keyboard is low to no impact to prevent damage to the nerves caused from repetitive typing.

### CROSS REFERENCE TO RELATED APPLICATION

This patent application is related to and claims priority from U.S. Provisional Patent Application Ser. No. 61/139,251 filed Dec. 19, 2008 and from U.S. Provisional Patent Application Ser. No. 61/139,812 filed Dec. 19, 2008.

### FIELD OF THE INVENTION

This invention generally pertains to keyboards.

Specifically, the present invention relates to a touch screen keyboard user interface.

### BACKGROUND OF THE INVENTION

The invention is particularly applicable to keyboards and will be described with particular reference thereto. However, it will be appreciated by those skilled in the art that the invention has broader applications and may also be adapted for use in laptop computers, man-machine interfaces and the like.

Many people have jobs that require copious amounts of typing. Standard keyboards facilitate disorders such as Carpal Tunnel Syndrome and repetitive stress injuries. The recurring motion involved in typing puts strain on the nerves and tendons in the hands eventually causing disabilities. A majority of workers' compensation cases deal with injuries resulting from repetitive stress from keyboard use.

Accordingly, it has been considered desirable to develop a new and improved keyboard which would overcome the foregoing difficulties and others while providing better and more advantageous overall results

### SUMMARY OF THE INVENTION

The present invention in several embodiments is an innovative touch screen keyboard designed to alleviate the strain that comes with using a computer everyday. This touch screen keyboard features a touch screen surface having touch screen keys which may be struck by an individual as if such individual were typing on a traditional computer keyboard. Such touch screen keyboard is split into sections which can be positioned by a user in specific relation to his or her hands for individual comfort. The touch screen keyboard is low to no impact to prevent damage to the nerves caused from repetitive typing. Several features of the present invention are similar to some features of U.S. Pat. Nos. 6,641,316 and 6,984,081 which are hereby incorporated by reference.

The present invention in several embodiments is a user-friendly laptop which includes a touch screen keyboard to reduce Repetitive Strain injuries. The touch screen keyboard features a touch screen surface having touch screen keys which may be struck by an individual as if such individual were typing on a traditional computer keyboard. Such touch screen keyboard includes a plurality of sections connected by a rotating means. Such sections may be selectively positioned by a user in specific relation to his or her hands for individual comfort. The touch screen keyboard is low to no impact to prevent damage to the nerves caused from repetitive typing. A separate additional touch screen keypad may also be included which can be placed on either the right or left side of the touch screen keyboard to accommodate a user's personal preference. The low impact touch screen keyboard prevents, alleviates, and eliminates repetitive strain injuries caused by inordinate amounts of typing.

### OBJECTS OF THE INVENTION

It is, therefore, one of the primary objects of the present invention to provide a touch screen keyboard.

Another object of the present invention is to provide an articulated keyboard structure with a touch screen interface.

Still another object of the present invention is to provide a laptop with a screen and a touch screen keyboard interface.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention; and together with the description serve to explain the principles and operation of the invention.

### BRIEF DESCRIPTION OF THE DRAWINGS

FIG. 1 is a general perspective view of one embodiment of the present invention.

FIG. 2 is a close up general perspective view of one embodiment of the present invention.

FIG. 3 is a general perspective view the number touch pad of one embodiment of the present invention.

FIG. 4 is a general perspective view of one embodiment of the present invention being used with a computer and computer screen.

FIG. 5 is a close up general perspective view of one embodiment of the present invention.

FIG. 6 is a partial perspective view of the invention according to another embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

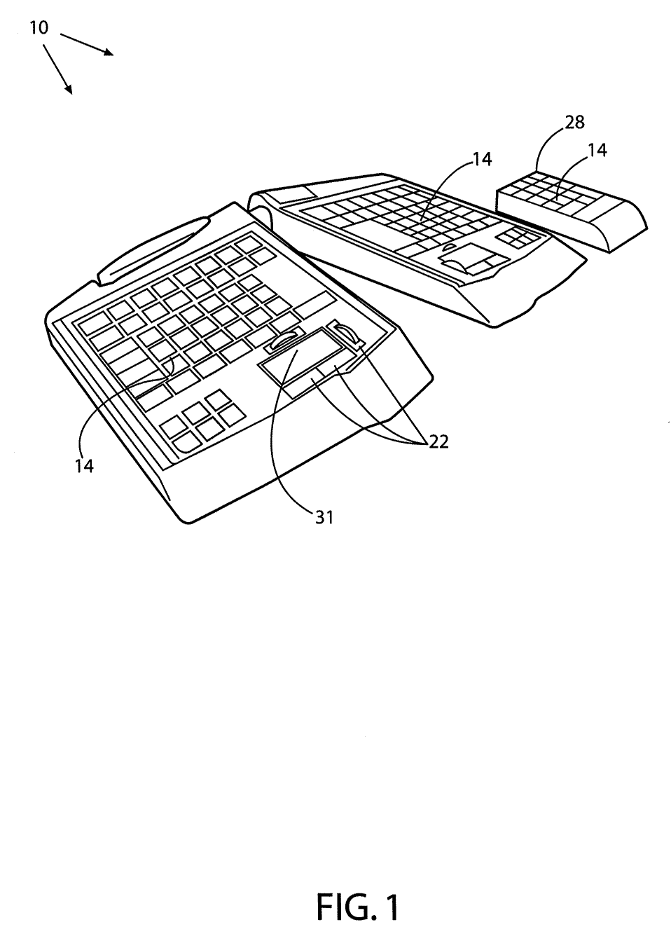

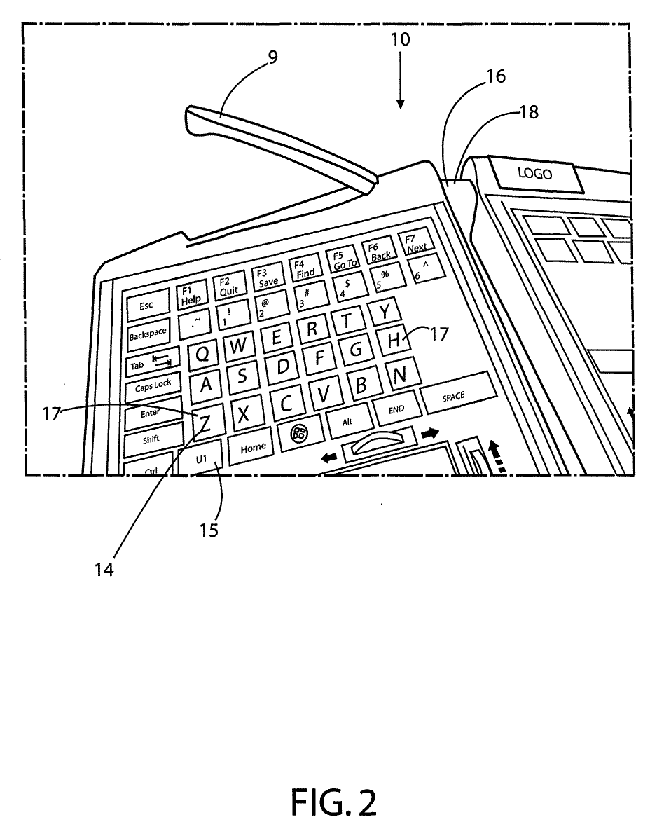

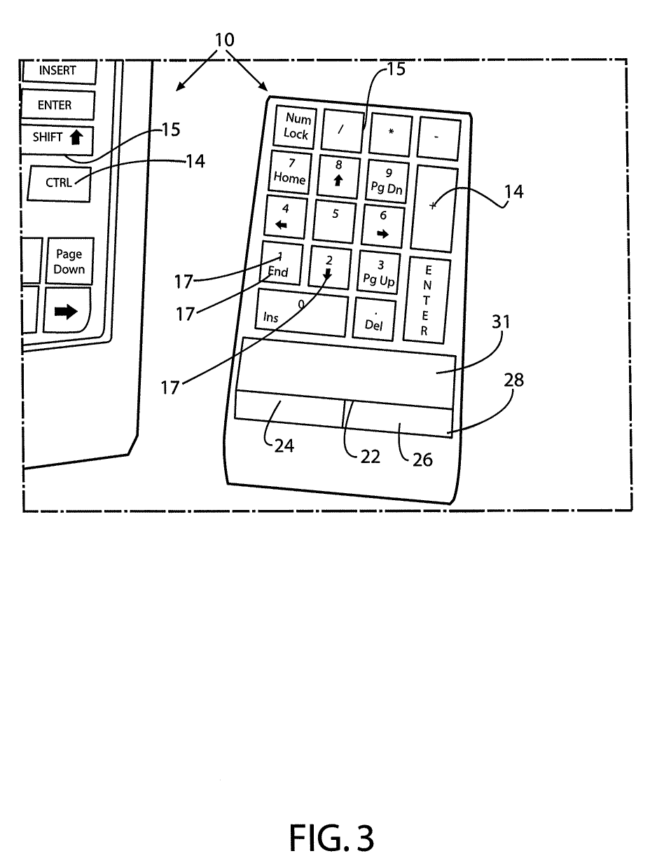

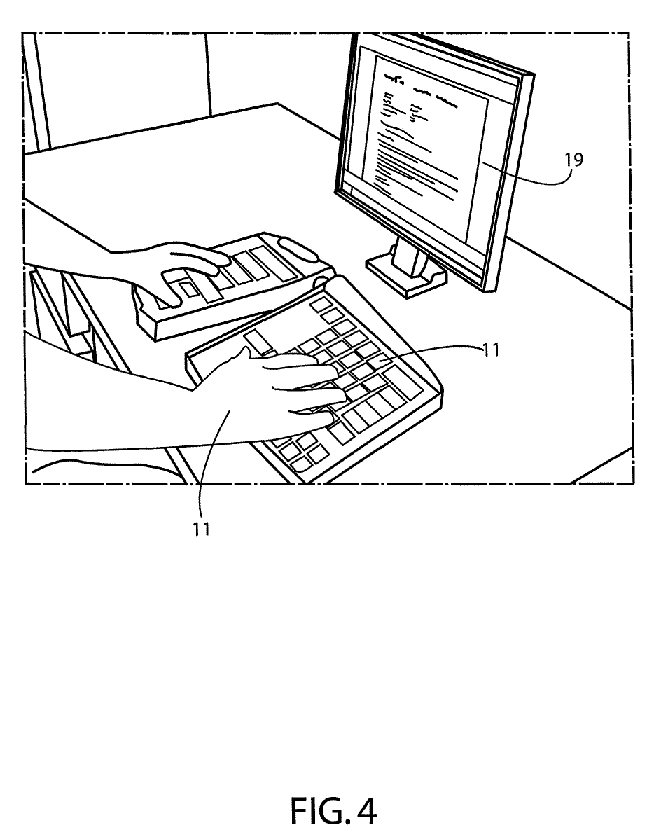

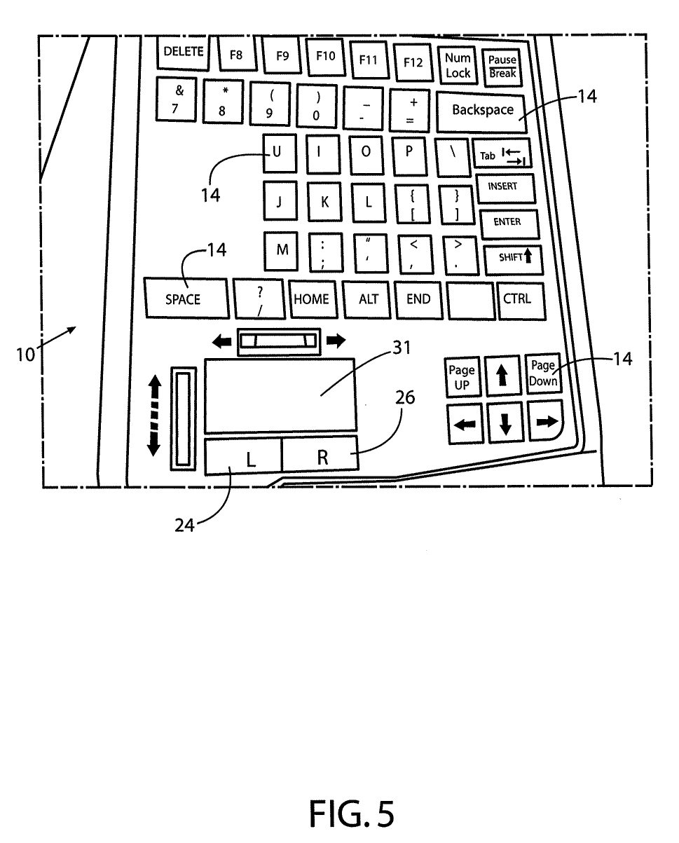

Reference is now made to FIGS. 1-5 which show several views of a preferred embodiment of the present invention. The present invention in several embodiments is a touch screen keyboard, generally designated 10, for use with a computer or other electronic device. Such touch screen keyboard 10 may be connected to such computer via a wireless connection (not shown) to allow for optimal mobility while typing or by a traditional wiring system. Such touch screen keyboard 10 may include a predetermined number of portions containing predetermined touch screen keys 14 thereon. At least two portions of such touch screen keyboard 10 may be joined by a rotating means 16. It is presently preferred that such rotating means 16 is a ball joint 18. An adjustment lever 9 is operably connected to at least one of such rotating means 16, such touch screen keyboard 10, and a combination thereof for adjusting the position of such portions of such touch screen keyboard 10. A locking means (not shown) is operably connected to such rotating means 16 for selectively locking and unlocking such rotating means. The rotating means 16 is meant to enable a user 11 to selectively position such portions of such touch screen keyboard 10 joined by such rotating means 16. Such touch screen keys 14 are meant to be arranged in the traditional positions on such touch screen keyboard 10 as on a traditional computer keyboard. Such touch screen keys 14 are covered by a touch sensitive surface disposed thereon which may consist of a smooth glass or plastic cover. Each touch screen key 14 may be separated by a frame member 15 disposed around a perimeter of such touch screen key 14 to establish a definitive boundary around each touch screen key 14. Each touch screen key 14 may include indicia 17 disposed thereon. Such indicia may include numbers, letters, symbols, words, and a combination thereof. It is meant that such indicia indicate to a user at least one of the character which will appear on a computer screen 19 operably connected to such touch screen keyboard 10 when such touch screen key 14 is touched, what action will be taken by a computer operably connected to such touch screen keyboard 10 when such touch screen key 14 is touched, and a combination thereof. It is contemplated that such touch sensitive surface may be black, while indicia 17 on such touch screen keys 14 is white. It is presently preferred that such touch screen keyboard 10 is split into two equal parts joined by such rotating means 16. It is presently preferred that each portion of such touch screen keyboard 10 includes a touch screen mouse control 22 disposed thereon, preferably closely adjacent a lower portion thereof. Such touch screen mouse control 22 includes a left click button 24 and a right click button 26 for controlling computer applications and a scrolling touch pad 31 for moving a cursor (not shown) on a computer screen. Such device 10 may further include an additional separate portion 28 not joined to such rotating means 16, such additional separate portion 28 having touch screen keys 14 disposed thereon including at least one of number touch screen keys, arrow touch screen keys, control touch screen keys, character touch screen keys, function touch screen keys, an addition sign touch screen key, a subtraction sign touch screen key, an equals sign touch screen key, and a combination thereof. Such separate portion 28 may include a left click button 24 and a right click button 26 for controlling computer applications and a scrolling touch pad 31 for moving a cursor (not shown) on a computer screen. It is presently preferred that such additional separate portion 28 is attachable to a computer via a wireless connection (not shown). According to one embodiment, a sound means (not shown) is operably connected to such touchpad keyboard 10 such that each of such touch screen keys 14 respond to a user's touch with a different sound. It is meant that such sounds enable such user 11 to become acclimated to such touch screen keyboard 10. It is presently preferred that a volume control (not shown) is operably connected to such sound means such that such user 11 may selectively reduce and increase the volume of such sounds.

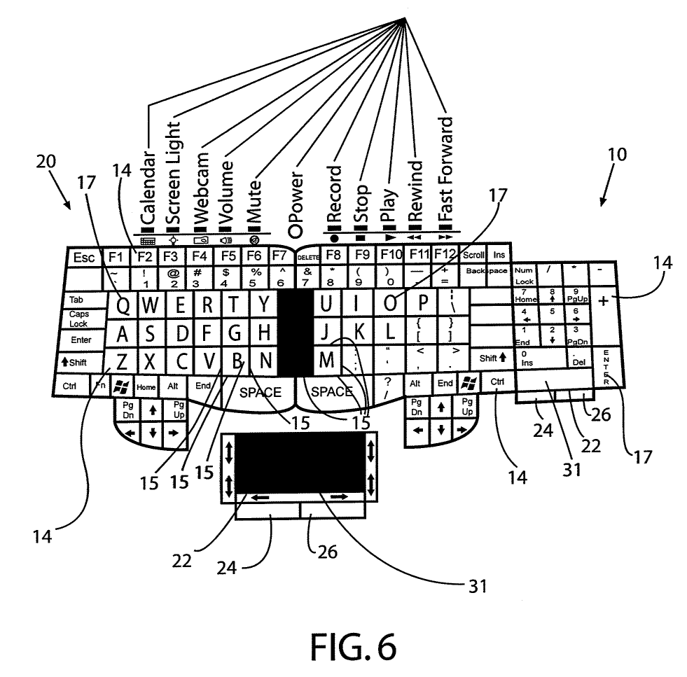

Reference is now made to FIG. 6 which shows a partial perspective view of the invention according to another embodiment of the invention. The present invention in several embodiments is a lightweight, durable laptop computer device, generally designated 20 and only partially shown, which has many unique features including an ergonomically designed touch screen keyboard, generally designated 10. Such touch screen keyboard 10 may be connected to at least one of a computer monitor (not shown), computer hardware (not shown), computer software (not shown), computer wiring (not shown), a computer hard drive (not shown) and a combination thereof via a wireless connection (not shown) to allow for optimal mobility while typing or by a traditional wiring system. Such computer device 20 includes all the standard programming, wiring, drives, software, power source, and monitor necessary for such computer device 20 to complete standard computer applications. Such touch screen keyboard 10 includes predetermined touch screen keys 14 disposed thereon. Such touch screen keys 14 are meant to be arranged in the traditional positions on such touch screen keyboard 10 as on a traditional computer keyboard. Such touch screen keys 14 are covered by a touch sensitive surface disposed thereon which may consist of a smooth glass or plastic cover. Each touch screen key 14 may be separated by a frame member 15 disposed around a perimeter of such touch screen key 14 to establish definitive boundaries around each touch screen key 14. Each touch screen key 14 may include indicia 17 disposed thereon. Such indicia may include numbers, letters, symbols, words, and a combination thereof. It is meant that such indicia 17 will indicate to a user (not shown) at least one of the character which will appear on a computer screen (not shown) of such laptop computer device 20 when such touch screen key 14 is touched, what action will be taken by such laptop computer device 20 when such touch screen key 14 is touched, and a combination thereof. It is contemplated that such touch sensitive surface may be black, while indicia 17 on such touch screen keys 14 is white. It is presently preferred that such touch screen keyboard 10 includes a touch screen mouse control 22 disposed thereon, preferably closely adjacent a lower portion thereof. Such touch screen mouse control 22 includes a left click button 24 and a right click button 26 for controlling computer applications and a scrolling touch pad 31 for moving a cursor (not shown) on a computer screen. Such device 10 may further include an additional separate portion (not shown), such additional separate portion having touch screen keys 14 disposed thereon including at least one of number touch screen keys, arrow touch screen keys, control touch screen keys, character touch screen keys, function touch screen keys, an addition sign touch screen key, a subtraction sign touch screen key, an equals sign touch screen key, and a combination thereof. It is presently preferred that such additional separate portion is attachable to a computer via a wireless connection (not shown). It is presently preferred that such additional separate section includes at least one touch screen mouse control disposed thereon. Such at least one touch screen mouse control includes a left click button and a right click button for controlling computer applications and a scrolling touch pad for moving a cursor (not shown) on a computer screen (not shown) of such laptop computer. According to another embodiment, bilateral key usage may be facilitated by such touch screen keyboard 10 including identical predetermined touch screen keys at dual locations on such touch screen keyboard 10. These identical keys located at dual locations may include at least one of a Backspace touch screen key, a Tab touch screen key, an Enter touch screen key, a Shift touch screen key, a Control touch screen key, an Alt touch screen key, an End touch screen key, an up arrow key, a down arrow key, a left arrow key, a right arrow key, and a combination thereof. According to yet another embodiment, a calendar button, a web cam, a web cam light, a power button, buttons for audio and video, including record, stop, play, rewind, and fast-forward, may be disposed on such touch screen keyboard 10 and operably connected to such laptop computer 20 for facilitating predetermined applications. According to still another embodiment, at least one wrist rest (not shown) may be operably connected to a lower portion of such keyboard 10 closely adjacent a lower edge thereof. It is presently preferred that at least two wrist rests are attached to such touch screen keyboard closely adjacent such lower edge thereof. It is meant that a first wrist rest is disposed to the left of such touch screen mouse control 22 for supporting a user's left wrist and a second wrist wrest be disposed to the right of such touch screen mouse control for supporting such user's right wrist. Such at least one wrist rest may be a memory foam wrist rest with a waterproof cover, for example rubber. However, the device is not meant to be limited as such and such at least one wrist rest may be a gel wrist rest. It is meant that such at least one wrist rest be easy to clean and comfortable. Such laptop computer device 20 may further include a widescreen monitor (not shown) to allow viewing in larger captions. Portions of the device 20, such as an outer housing (not shown), may be made of plastic to provide a lightweight, manageable unit. According to still another embodiment, at least one gel wrist rest (not shown) may be operably connected to a lower portion of such keyboard 10. Such laptop computer device 20 may further include a widescreen monitor (not shown) to allow viewing in larger captions. Portions of the device 20, such as an outer housing (not shown), may be made of plastic to provide a lightweight, manageable unit. According to one embodiment, a sound means (not shown) is operably connected to such touchpad keyboard such that such each of such touch screen keys respond to a user's touch with a different sound. It is meant that such sounds enable such user to become acclimated to such touch screen keyboard. It is presently preferred that a volume control (not shown) is operably connected to such sound means such that such user may selectively reduce and increase the volume of such sounds.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

What is claimed:

1. A keyboard comprising: a first keyboard segment, the first keyboard segment including a first touch screen; a second keyboard segment, the second keyboard segment including a second touch screen; and a joint coupling the first keyboard segment and the second keyboard segment, the joint allowing movement of the first keyboard segment and the second keyboard segment relative to one another, the joint including a locking mechanism, the locking mechanism locking the first keyboard segment relative the second keyboard segment, the locking mechanism including a cam, the joint including a ball, the ball affixed to one of the keyboard segments, the cam directly contacting the ball.

2. The keyboard of claim 1, wherein: the first keyboard segment contains a recess and the locking mechanism includes a lever, the lever positioned either in or out of the recess in the first keyboard segment when the pivoting of the first keyboard segment and the second keyboard segment is either locked or unlocked by the locking mechanism.

3. The keyboard of claim 1, wherein: the locking mechanism includes a bearing element and a cam, the cam being connected to the bearing element, movement of the cam causing movement of the bearing element.

4. The keyboard of claim 1, wherein: the first keyboard segment and the second keyboard segment are positionable relative to one another to reduce pronation of a user's wrists.

5. The keyboard of claim 1, wherein: the joint is adapted to allow pivoting of the first keyboard segment and the second keyboard segment in both horizontal and vertical directions.

6. The keyboard of claim 1, wherein: at least the first touch screen is a multipoint touch screen.

7. A laptop computer comprising: a first keyboard segment, the first keyboard segment including a first touch screen; a second keyboard segment, the second keyboard segment including a second touch screen; and a computer screen.

8. A laptop computer as claimed in claim 7, further comprising a third keyboard segment, the third keyboard segment including a third touch screen.

9. A laptop computer as claimed in claim 8, wherein said third keyboard segment is wirelessly connected to said laptop computer.

10. A keyboard comprising: a first keyboard segment, the first keyboard segment including a first touch screen; a second keyboard segment, the second keyboard segment including a second touch screen; and a joint coupling the first keyboard segment and the second keyboard segment, the joint including a socket and a ball retained therein and allowing the first keyboard segment and the second keyboard segment to pivot relative to one another; and a locking mechanism, the locking mechanism locking the joint and thereby restricting the pivoting of the first keyboard segment relative to the second keyboard segment, wherein the socket retains the ball in both locked and unlocked positions of the locking mechanism, the ball being affixed to one of the keyboard segments, the ball and socket being frictionally coupled when the locking mechanism is in a locked position, the ball and socket being urged towards one another when the locking mechanism is in a locked position the socket maintaining substantially the same shape when the locking mechanism is in either a locked or unlocked position.

11. The keyboard of claim 10, wherein: the locking mechanism includes a movable bearing element, the movable bearing element having a hemispherical surface.

12. The keyboard of claim 10, wherein: the locking mechanism includes a lever movable from a locking position to an unlocking position.

13. The keyboard of claim 10, further comprising a detached third keyboard segment including a third touch screen.
